(19) United States
(12) Patent Application Publication
(10) Pub. No.: US 2009/0141739 A1
(43) Pub. Date: Jun. 4, 2009

(54) METHOD AND APPARATUS FOR PROCESSING BANDWIDTH-ALLOCATION INFORMATION IN CABLE MODEM WITH MULTIPLE TRANSMITTING AND RECEIVING CHANNELS

(76) Inventors: Seung Eun HONG, Daejeon (KR); Ho Jin KWON, Seoul (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/325,682

(22) Filed: Dec. 1, 2008

(30) Foreign Application Priority Data
Dec. 4, 2007 (KR) 10-2007-0125147

(51) Int. Cl. H04J 3/22

(52) U.S. Cl. 370/468

(57) ABSTRACT

A method and apparatus for processing bandwidth-allocation information in a cable modem (CM) with multiple transmitting and receiving channels is provided. A method of processing bandwidth-allocation information in a CM with multiple transmitting and receiving channels, the method including: receiving, by a Mini-slot Allocation Packet (MAP) pre-processor, MAP data from a Media Access Control (MAC) Management Message (MMM) processor, reconstructing the MAP data into an Information Element (IE), and sorting bandwidth-allocation IEs between channels according to a time sequence; reporting, to an upstream scheduler, whether upstream data is generated, and returning, by the upstream scheduler, the bandwidth-allocation information for upstream data transmission of the IE sorted by the MAP pre-processor; and performing, by a back-off controller, a back-off function and returning contention-based resource-request opportunity information when the back-off controller receives a back-off driving signal from the upstream scheduler.

### CROSS-REFERENCE TO RELATED APPLICATION

This application claims priority from Korean Patent Application No. 10-2007-0125147, filed on Dec. 4, 2007, in the Korean Intellectual Property Office, the entire disclosure of which is incorporated herein by reference.

### BACKGROUND OF THE INVENTION

1. Field of the Invention

The present invention relates to a technology of processing bandwidth-allocation information messages in a Data Over Cable Service Interface Specifications (DOCSIS)-based cable modem, and more particularly, to a method and apparatus for processing bandwidth-allocation information in a cable modem with multiple transmitting and receiving channels.

This work was supported by the IT R&D program of MIC/IITA [2006-S-019-02, The Development of Digital Cable Transmission and Receive System for 1 Gbps Downstream].

2. Description of Related Art

A currently-released cable modem (CM) processes Mini-slot Allocation Packet (MAP) messages including bandwidth-allocation information about a single transmitting channel, the MAP messages being transmittedover the single receiving channel. A MAP message corresponds to a message transmitted by a single Cable Modem Termination System (CMTS) to a plurality of CMs, and includes the bandwidth-allocation information to enable the plurality of CMs to transmit an upstream message. The bandwidth-allocation information in a MAP is sorted by a time ascending series, and the MAP messages for a single upstream channel are also sorted by the time ascending series and are transmitted to the CM. Accordingly, processing of the MAP messages is simple.

However, the CM following recently-established DOCSIS 3.0 may have multiple transmitting and receiving channels, and the MAP messages with respect to an individual upstream transmitting channel may be transmitted to an individual downstream receiving channel corresponding to the upstream channel. In particular, since the bandwidth-allocation information of the MAP messages between channels is not sorted according to a time sequence, a method of processing the bandwidth-allocation information is required.

### SUMMARY OF THE INVENTION

An aspect of the present invention provides a method and apparatus for effectively transmitting packets to a plurality of upstream transmitting channels since bandwidth-allocation information between channels of Mini-slot Allocation Packet (MAP) messages is sorted according to a time sequence, and the sorted bandwidth-allocation information is sequentially used.

According to an aspect of the present invention, there is provided a method of processing bandwidth-allocation information in a cable modem (CM) with multiple transmitting and receiving channels, the method including: receiving, by a MAP pre-processor, MAP data from a Media Access Control (MAC) Management Message (MMM) processor, reconstructing the MAP data into an Information Element (IE), and sorting bandwidth-allocation IEs between channels according to a time sequence; reporting, to an upstream scheduler, whether upstream data is generated, and returning, by the upstream scheduler, the bandwidth-allocation information for upstream data transmission of the IE sorted by the MAP pre-processor; and performing, by a back-off controller, a back-off function and returning contention-based resource-request opportunity information when the back-off controller receives a back-off driving signal from the upstream scheduler.

According to another aspect of the present invention, there is provided a MAP pre-processor including: an IE filtering and reconstruction unit to perform filtering and to reconstruct a MAP IE; a first buffer to filter the IE and to store a bandwidth-allocation IE of each channel reconstructed by a reconstruction unit; a classifier to receive Cyclic Redundancy Check (CRC) result information from the MMM processor, to process the CRC result information, and to classify the bandwidth-allocation IEs by an Upstream Channel Identifier (UCID) value, a Service Identifier (SID) value, and an Interval Use Code (IUC) value, the bandwidth-allocation IEs being read from the first buffer; a second buffer to store non-contention bandwidth-allocation information and contention bandwidth-allocation information based on the classifying of the classifier; a sorter to sort two time-sorted IE lists with each other and to perform time sort of the two IE lists; and a third buffer to store the IEs being time-sorted between the channels according to the sorter.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a configuration of a Mini-slot Allocation Packet (MAP) message including bandwidth-allocation information received by a cable modem (CM) following Data Over Cable Service Interface Specifications (DOCSIS) from a Cable Modem Termination System (CMTS) according to an exemplary embodiment of the present invention;

FIG. 2 is a diagram illustrating a CM with multiple transmitting and receiving channels according to an exemplary embodiment of the present invention;

FIG. 3 is a block diagram illustrating a MAP pre-processor of FIG. 2 for multi-channel MAP processing;

FIG. 4 illustrates a buffer operation and a function performed by the MAP pre-processor of FIG. 2;

FIG. 5 is a flowchart illustrating filtering and Information Element (IE) reconstruction of a multi-channel MAP pre-processor according to an exemplary embodiment of the present invention;

FIG. 6 is a flowchart illustrating an operation of a classifier of a multi-channel MAP pre-processor according to an exemplary embodiment of the present invention;

FIG. 7 is a flowchart illustrating an operation of a sorter of a multi-channel MAP pre-processor according to an exemplary embodiment of the present invention;

FIG. 8 is a flowchart illustrating an operation of a scheduler of a multi-channel MAP processor of FIG. 2; and

FIG. 9 is a flowchart illustrating an operation of a back-off controller of the multi-channel MAP processor of FIG. 2.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

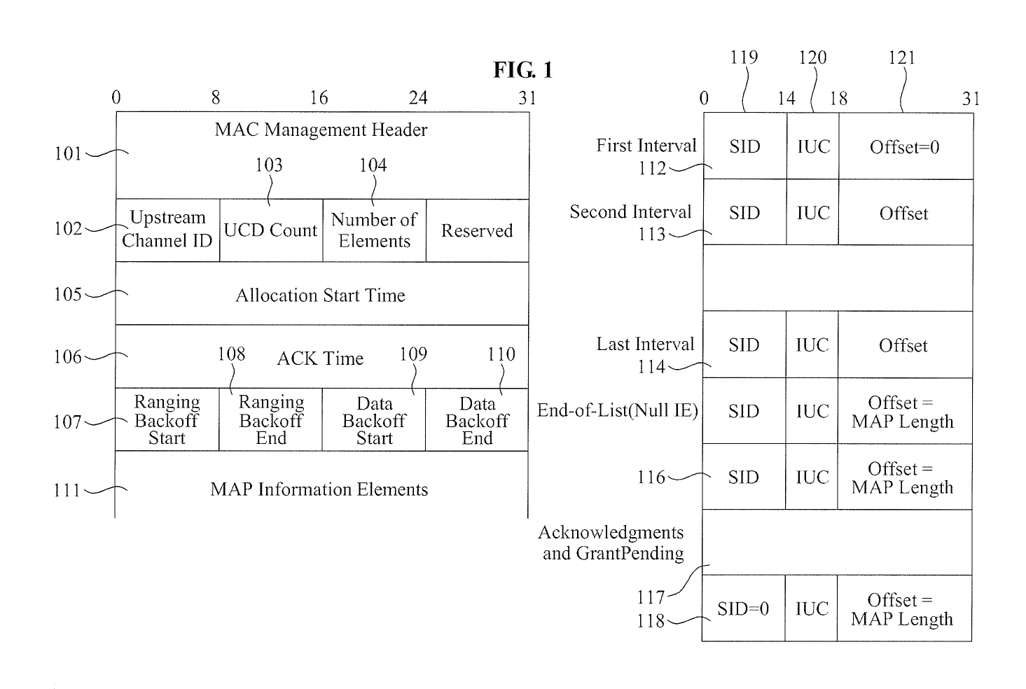

FIG. 1 illustrates a configuration of a Mini-slot Allocation Packet (MAP) message including bandwidth-allocation information received by a cable modem (CM) following Data Over Cable Service Interface Specifications (DOCSIS) 3.0 from a Cable Modem Termination System (CMTS) according to an exemplary embodiment of the present invention.

Hereinafter, referring to FIG. 1, the configuration and a function of the MAP message according to an exemplary embodiment of the present invention are described.

Many terms and abbreviations are used for describing the configuration of the MAP message, and detailed descriptions of the used terms and abbreviations may be found in DOCSIS (CM-SP-MULPIv3.0-I03-070223).

The MAP message includes a Media Access Control (MAC) Management Message (MMM) header 101 including information enabling a CM MAC to easily perform appropriate processing. An Upstream Channel Identifier (UCID) 102 denotes which upstream frequency channel the MAP message is applied to. An Uplink Channel Descriptor (UCD) count 103 denotes a configuration change count value of a UCD message describing upstream burst parameters applied to a MAP.

A field of a number of Information Elements (IEs) 104 denotes a number of IEs included in the MAP message. An allocation start time 105 denotes a start time of bandwidth information allocated based on the MAP, and the start time denotes a time having passed from a time of initializing the CMTS and includes a mini-slot unit. A response (an acknowledgment (ACK) time) 106 denotes a time having passed from the time of initializing the CMTS, and denotes a latest time when processing is completed in upstream data communication. This time information is used by the CM for collision detection.

A ranging backoff start 107 is expressed as an exponent of two and denotes an initial backoff window size for initial ranging contention. A ranging backoff start value may be set from 0 to 15. A ranging backoff end 108 is expressed as an exponent of two and denotes a final backoff window size for initial ranging contention. A ranging backoff end value may be set from 0 to 15.

A data backoff start 109 is expressed as an exponent of two and denotes an initial backoff window size for resource-request contention. A data backoff start value may be set from 0 to 15. A data backoff end 110 is expressed as an exponent of two and denotes a final backoff window size for resource-request contention. A data backoff end value may be set from 0 to 15.

MAP IEs 111 define time slots transmitted by individual CMs to a specific upstream channel. A plurality of intervals of the MAP such as a first interval 112, a second interval, and a last interval 114 define individual time slots. Each interval 112 to 114 shows a Station or Service Identifier (SID) value 119, and the SID value 119 identifies the CM that may use a corresponding interval. An interval in which the SID value corresponds to 0 denotes a list end of the intervals, and denotes that all intervals are defined.

An Interval Use Code (IUC) 120 defines burst parameters used for a predetermined time slot. The burst parameters include a modulation type, for example, Quadrature Phase Shift Keying (QPSK) or 16-Quadrature Amplitude Modulation (QAM). An offset 121 denotes a time when each interval starts based on a common time reference value denoting a value of the allocation start time 105. An offset value of 0 denotes a start of the first interval 112. Alternatively, unused intervals 116 and 118 including a fixed length and type may be shown after the last interval 114 in each MAP. Response and allocation waiting (Acknowledgments and GrantPending) intervals 117 may be optionally shown between interval lists, however, the response and allocation waiting intervals 117 are generally shown after the last interval 114.

As illustrated in FIG. 1, the bandwidth-allocation information in the MAP is sorted by a time ascending series, and MAP messages for a single upstream channel are also sorted by the time ascending series and are transmitted to the CM, thereby enabling the MAP messages to be easily processed. However, the CM following currently-established DOCSIS 3.0 may include multiple transmitting and receiving channels, and the MAP messages with respect to an individual upstream transmitting channel may be transmitted to an individual downstream receiving channel corresponding to the upstream channel. In particular, the bandwidth-allocation information of the MAP messages between the channels is not sorted according to a time sequence.

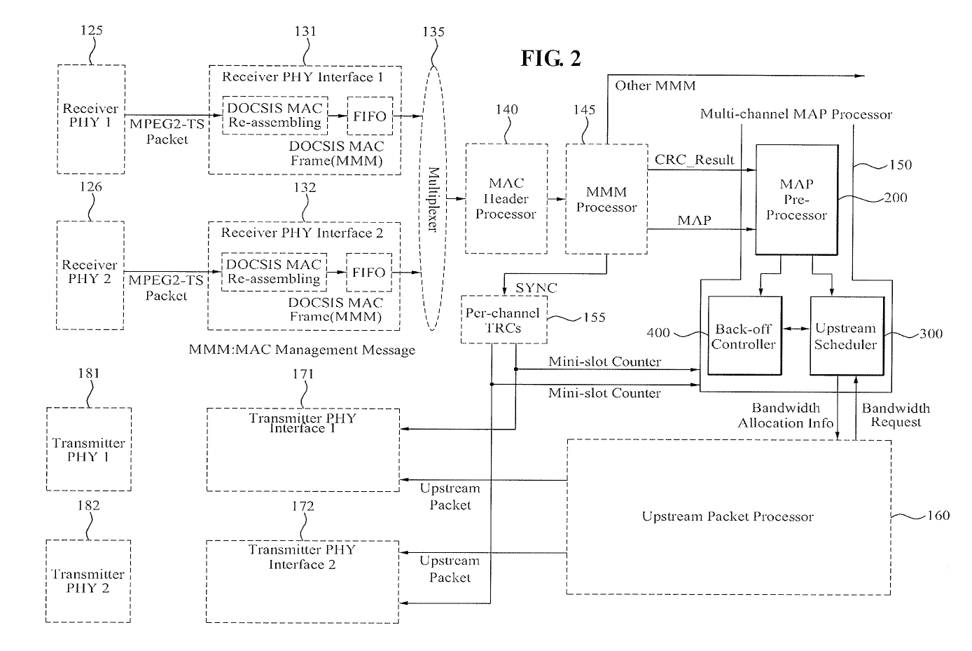

FIG. 2 is a diagram illustrating a CM with multiple transmitting and receiving channels according to an exemplary embodiment of the present invention.

Hereinafter, referring to FIG. 2, an MMM flowchart of the CM with the multiple transmitting and receiving channels according to an exemplary embodiment of the present invention is described.

The CM with the multiple transmitting and receiving channels according to an exemplary embodiment of the present invention assumes two channels for downstream receiving and two channels for upstream transmission, and blocks directly related to an exemplary embodiment of the present invention is shown by solid lines while blocks not directly related to an exemplary embodiment of the present invention is shown by dotted lines.

Physical layer (PHY) receivers 125 and 126 of the CM transmit, to PHY receiver interfaces 131 and 132 of a MAC apparatus, Motion Picture Experts Group 2-Transport Stream (MPEG2-TS) packets received from a specific downstream channel. The PHY receiver interfaces 131 and 132 extract a DOCSIS MAC frame from the received MPEG2-TS packets, classifies the extracted DOCSIS MAC frame into user data and an MMM, and stores the user data and the MMM in a buffer.

A channel multiplexer 135 of the MAC apparatus reads the MMM from FIFOs of the PHY receiver interfaces 131 and 132, and a MAC header processor 140 transmits the MMM to an MMM processor 145 after performing a DOCSIS MAC header processing function such as header sequence inspection. The MMM processor 145 classifies the received MMMs into synchronization (SYNC), a MAP, and other MMMs, and performs Cyclic Redundancy Check (CRC) of the MMMs.

A SYNC message including timing information is transmitted to a Timing ReGeneration (TRG) block and generates a mini-slot counter value for each channel. All MMMs other than the SYNC and the MAP are generally transmitted to a software embodiment block of the MAC apparatus for software processing. A MAP message is transmitted to a multi-channel MAP processor 150 being an apparatus for the present invention. MAP message data transmitted to the multi-channel MAP processor 150 does not need to wait until a CRC result is completed. In descriptions of the present function, it is assumed that the CRC result is transmitted to the multi-channel MAP processor 150 after final MAP data is transmitted.

The multi-channel MAP processor 150 generally includes three functional blocks, that is, a MAP pre-processor 200, an upstream scheduler 300, and a back-off controller 400.

The MAP pre-processor 200 receives MAP data from the MMM processor 145, configures an IE described below for easy internal processing, sorts bandwidth-allocation IEs between channels according to a time sequence, and deletes corresponding MAP data when a CRC result value indicates failure.

When upstream data occurrence is reported to the upstream scheduler 300 by an upstream packet processor 160, the upstream scheduler 300 returns bandwidth-allocation information for corresponding data transmission. First, the upstream scheduler 300 verifies whether the bandwidth-allocation information that may be transmitted without contention exists, and requests a contention-based resource-request opportunity for the back-off controller 400 when the bandwidth-allocation information that may be transmitted without contention does not exist. The back-off controller 400 performs a back-off function and returns contention-based resource-request opportunity information when the back-off controller 400 receives a back-off driving signal from the upstream scheduler 300. The three functional blocks of the multi-channel MAP processor 150 are described in detail below.

When upstream data is generated, the upstream packet processor 160 requests bandwidth information for the upstream scheduler 300 for corresponding packet transmission, and the bandwidth-allocation information is reported to the upstream packet processor 160 by the upstream scheduler 300, and the upstream packet processor 160 generates an upstream packet and transmits the upstream packet to PHY transmitter interfaces 171 and 172 of an upstream channel. An upstream packet configuration may have a configuration of adding the bandwidth-allocation information (a transmission time, a transmitting channel, an IUC, and the like) to a DOCSIS MAC frame configuration (referring to CM-SP-MULPIv3.0-I03-070223), and enables the PHY transmitter interfaces 171 and 172 being described below to easily perform interface with PHY transmitters 181 and 182.

The PHY transmitter interfaces 171 and 172 are transmitted to the PHY transmitters 181 and 182 corresponding to the inputted upstream packets, and the PHY transmitters 181 and 182 perform a PHY function and finally transmit the upstream packet to a CMTS.

Hereinafter, a function of the multi-channel MAP processor 150 is described in detail using a specific exemplary embodiment and figures. For this, a CM may use two upstream transmitting channels, and a UCID of each channel corresponds to UCID_A and UCID_B. A service flow for upstream packet transmission supports a total of two channels, and each Service Flow Identifier (SFID) corresponds to SFID_a and SFID_b.

SFID_a service flow may perform channel bonding of UCID_A and UCID_B and may transmit the upstream packet. SID_aA is used for UCID_A channel, and SID_aB is used for UCID_B channel as SIDs used in this instance. SFID_b service flow may transmit the upstream packet using only UCID_B, and an SID used in this instance corresponds to SID_bB. Setting information is summarized in Table 1.

TABLE 1
Service flow and upstream channel setting of CM considered as an
exemplary embodiment of the present invention.

| SFID | SID for UCID_A | SID for UCID_B |
|---|---|---|
| SFID_a | SID_aA | SID_aB |
| SFID_a | No allocation | SID_bB |

For convenience of description, an exemplary embodiment of the present invention assumes that a mini-slot size of two upstream channels (UCID_A and UCID_B) are the same. A start time priority of a bandwidth-allocation information interval between two channels may be compared using a mini-slot count value by assuming a mini-slot of the same size. The mini-slot count value for each channel provided by a TRC block 155 of FIG. 2 is provided as the same value between channels. However, a different upstream channel generally has a different mini-slot size. In order to determine the start time priority of the bandwidth-allocation information interval between channels having the different mini-slot size, a specific interval start time denoted as a mini-slot unit in a specific channel may be converted into a 10.24 MHz tick count value using the following Equation and may be compared.

10.24 MHzTickCount=MSCount×UnitMSSize

In the above-described Equation, UnitMSSize denotes the mini-slot size fixed for each channel, and a unit of UnitMSSize denotes a number of 10.24 MHz ticks.

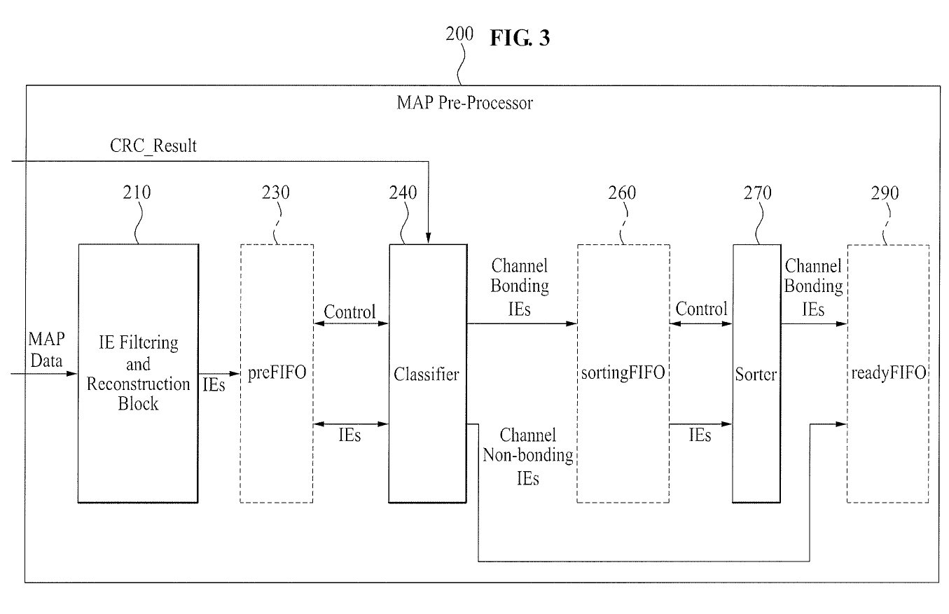

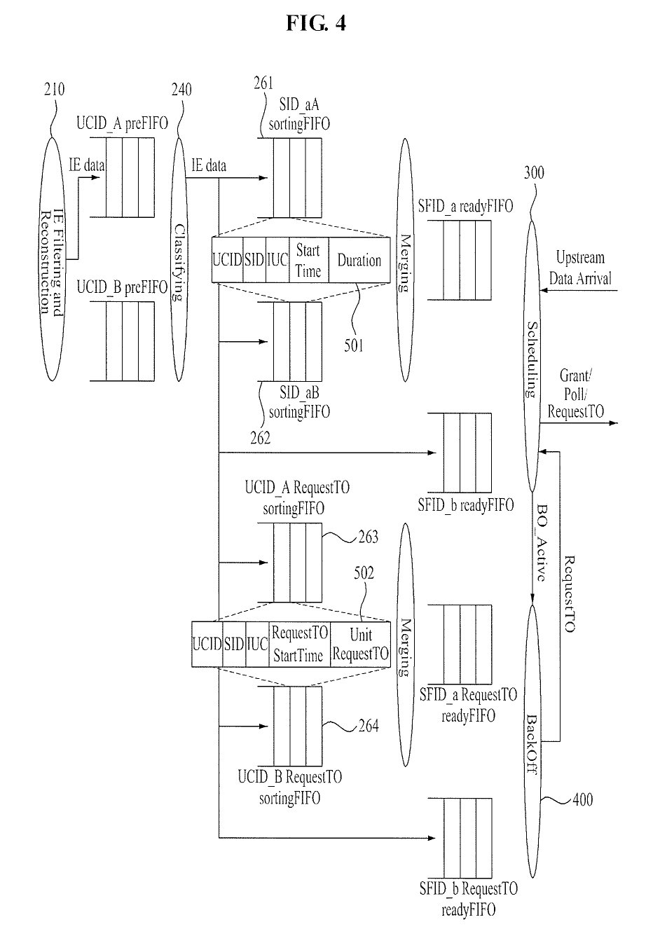

FIG. 3 is a block diagram illustrating the MAP pre-processor 200 of FIG. 2 for multi-channel MAP processing, and FIG. 4 illustrates a buffer operation and a function performed by the MAP pre-processor 200 of FIG. 2.

Hereinafter, referring to FIGS. 3 and 4, a configuration and a function of the MAP pre-processor 200 according to an exemplary embodiment of the present invention are described.

The MAP pre-processor 200 according to an exemplary embodiment of the present invention includes three functional blocks classified into an IE filtering and reconstruction block 210, a classifier 240, and a sorter 270, and three buffers classified into a preFIFO 230, a sorting FIFO 260, and a readyFIFO 290.

When a CM is manufactured, a number of transmitting channels and a number of service flows that may be supported are predetermined. The buffers are set in advance based on the number of transmitting channels and the number of service flows.

The preFIFO 230 is set for each upstream transmitting channel, and UCID_A preFIFO and UCID_B preFIFO are provided in Table 1.

The sortingFIFO 260 is classified into a sortingFIFO storing non-contention bandwidth-allocation information and a RequestTO sortingFIFO storing contention bandwidth-allocation information, is respectively classified by a service flow again, and is set for each upstream transmitting channel again. When two upstream channels and two service flows are supported as illustrated in Table 1, SID_aA sortingFIFO, SID_aB sortingFIFO, SID_bA sortingFIFO, SID_bB sortingFIFO, SID_aA RequestTO sortingFIFO, SID_aB RequestTO sortingFIFO, SID_bA RequestTO sortingFIFO, and SID_bB RequestTO sortingFIFO are supported.

The sorting FIFOs may be unused based on service flow information being dynamically set while the CM communicates with a CMTS. When SFID_b service flow does not perform channel-bonding and uses UCID_B channel being a single channel as illustrated in the setting of Table 1, SID_bA sortingFIFO. SID_bB sortingFIFO. SID_bA RequestTO sortingFIFO, and SID_bB RequestTO sortingFIFO corresponding to an SFID_b service flow are not used, since the bandwidth-allocation information for the corresponding service flow does not need time sort.

The readyFIFO 290 is classified into a readyFIFO storing non-contention bandwidth-allocation information and a RequestTO readyFIFO storing contention bandwidth-allocation information, and is respectively classified by the service flow again, similar to the sortingFIFO 260, however, and the readyFIFO 290 is not classified by the upstream transmitting channel since IEs being time-sorted between the channels are stored. In the setting of Table 1, SFID_a readyFIFO, SFID_b readyFIFO, SFID_a RequestTO readyFIFO, and SFID_b RequestTO readyFIFO are provided.

The IE filtering and reconstruction block 210 receiving MAP data from the MMM processor 145 perform UCID filtering, filtering using an allocation start time, and SID filtering, reconstructs a correct MAP IE into a configuration described below, and stores the configuration in UCID_A preFIFO and UCID_B preFIFO for each upstream channel.

The classifier 240 receives CRC result information from the MMM processor 145. When a CRC result value indicates success, the classifier 240 reads a reconstruction IE from a corresponding preFIFO, and advances processing. When the CRC result value indicates failure, the classifier 240 deletes MAP IEs stored in the corresponding preFIFO. The classifier 240 classifies the bandwidth-allocation IEs read from the preFIFO by a UCID value, an SID value, and an IUC value.

When the SID value corresponds to SID_aA or SID_aB corresponding to SFID_a in the setting of Table 1, the IEs are stored in the sortingFIFO 260 for time sort described below. In order to easily apply a merge sort algorithm using a fact that the IEs in the same MAP message are time-sorted, the sorting FIFO operates for each channel. An IE having SID_aA is stored in SID_aA sortingFIFO, and an IE having SID_aB is stored in SID_aB sortingFIFO, and two IE lists being time-sorted are merged with each other and are time-sorted by the sorter 270 described below.

The classifier 240 configures resource-request opportunity information of a contention scheme described below for channel-bonding back-off for resource-request message transmission of SFID_a service flow in the case of the IE having an SID of broadcast (0×3FFE) and IUC=1, stores the resource-request opportunity information in UCID_A RequestTO sortingFIFO in the case of channel information of UCID_A, stores the resource-request opportunity information in UCID_B RequestTO sortingFIFO in the case of channel information of UCID_B, and enables the sorter 270 to perform a merging process for time sort.

SID_bB IE corresponding to SFID_b flow not performing channel-bonding is immediately stored in the readyFIFO 290, and the readyFIFO 290 operates for each service flow, and SID_bB IE is stored in SFID_b readyFIFO. The IE of SID=0×3FFE and IUC=1 is not stored in the sorting FIFO and is immediately stored in SFID_b RequestTO readyFIFO for back-off for resource-request message transmission of SFID_b service flow.

The sorter 270 accesses the non-contention sorting FIFO (SID_aA sortingFIFO and SID_aB sortingFIFO) classified by the channel of SFID_a service flow supporting the channel-bonding, reads the stored IEs, performs time sort, and subsequently stores the time-sorted IEs in SFID_a RequestTO readyFIFO. The sorter 270 accesses the contention sortingFIFO (SID_aA RequestTO sortingFIFO and SID_aB RequestTO sortingFIFO) classified by the channel of SFID_a service flow, reads the stored IEs, performs time sort, and subsequently stores the time-sorted IEs in SFID_a RequestTO readyFIFO.

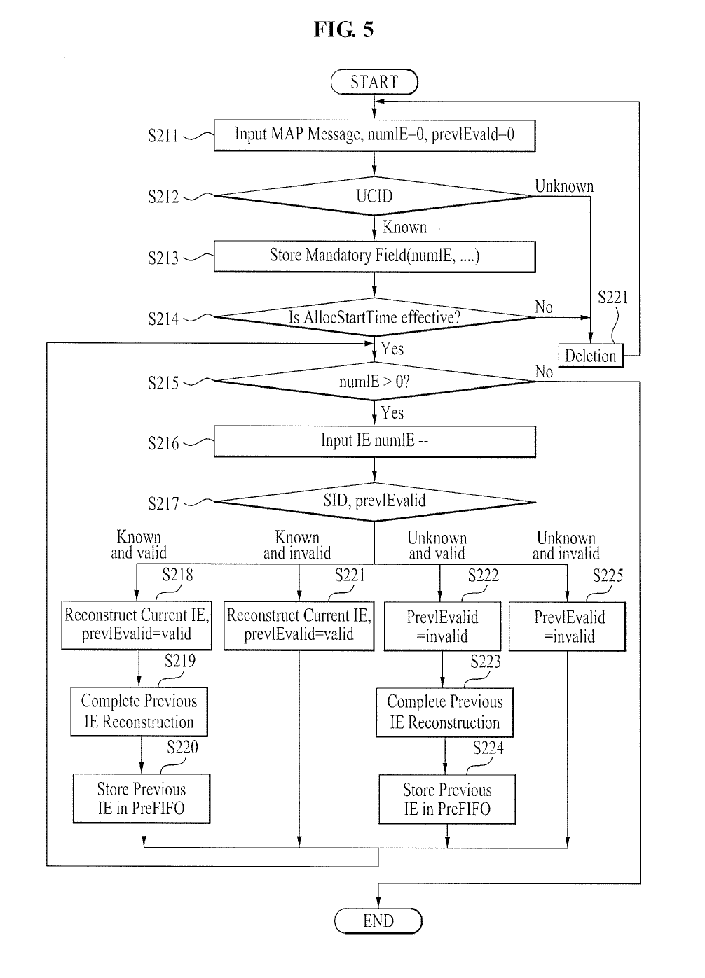

FIG. 5 is a flowchart illustrating filtering and IE reconstruction of a multi-channel MAP pre-processor according to an exemplary embodiment of the present invention.

The IE filtering and reconstruction block 210 receives MAP data from the MMM processor 145 in operation S211 and starts an operation. As illustrated in FIG. 1, a UCID value being a first byte of a MAP message payload is verified in operation S212, and when the UCID value is known (UCID_A or UCID_B in the setting of Table 1), mandatory fields 102 to 110 of the subsequently-received MAP message payload are received in operation S213. In operation S214, whether a value of the allocation start time (the bandwidth allocation time) 105 from among the received mandatory fields is effective is determined. Effectiveness of the bandwidth allocation time value is determined using MAP information having the same UCID value and Equation 1:

Current AllocStartTime>=previous AllocStartTime+previous MAP Length+1. [Equation 1]

When fulfilling a condition of the above-described Equation 1, it is a valid bandwidth allocation time, and the IEs 112 to 117 of FIG. 1 are continuously received in operation S216. In operation S215, the number of IEs 104 is stored in a numIE variable in order to recognize an end of a MAP payload, and whether the value corresponds to 0 is verified. In operation S216, each time the single IE is received, the numIE variable is decremented by one. When the single complete IEs 112 to 117 are received, comparison is performed to verify whether a value of the SID 119 is related to the CM in operation S217. When the value of the SID 119 is related to the CM (SID_aA in the case of UCID_A, SID_aB or SID_bB in the case of UCID_B, and a broadcast SID having 0×3FFE regardless of a channel in Table 1), the corresponding IE is reconstructed for subsequent processing in operations S218 and S221.

The IE is reconstructed in a configuration of an IE 501 of FIG. 4. An SID and an IUC in the configuration of the IE 501 are the same as an SID and an IUC of the received IE, and a StartTime of the IE 501 denotes a start time of the IE and denotes a value of summing the bandwidth allocation time 105 and an offset 121 value of the received IE. A duration of the IE 501 denotes a length of an input IE interval, and may not be calculated using only the valid IE undergoing currently-received SID filtering. In operation S219, the offset value of the next IE is received and is determined using Equation 2:

current IE Duration=next IE Offset−current IE Offset. [Equation 2]

In operation S223, since the duration of the IE 501 is determined by an offset of a next input IE and an offset of a current input IE as illustrated in the above-described Equation 2, the offset of the currently-inputted IE needs to be used for calculating the duration for previous IE reconstruction when a previous IE is valid even when the subsequently-inputted IE is deleted by SID filtering in operations S222 and S225.

In operations S220 and S224, only the IE for which IE reconstruction is completed is stored in the preFIFO 230 classified by the upstream channel.

In operation S221, when the allocation start time is determined to be ineffective using the above-described Equation 1 in operation S214, the MAP data, received up until a current time, and the subsequently-received MAP data need to be deleted.

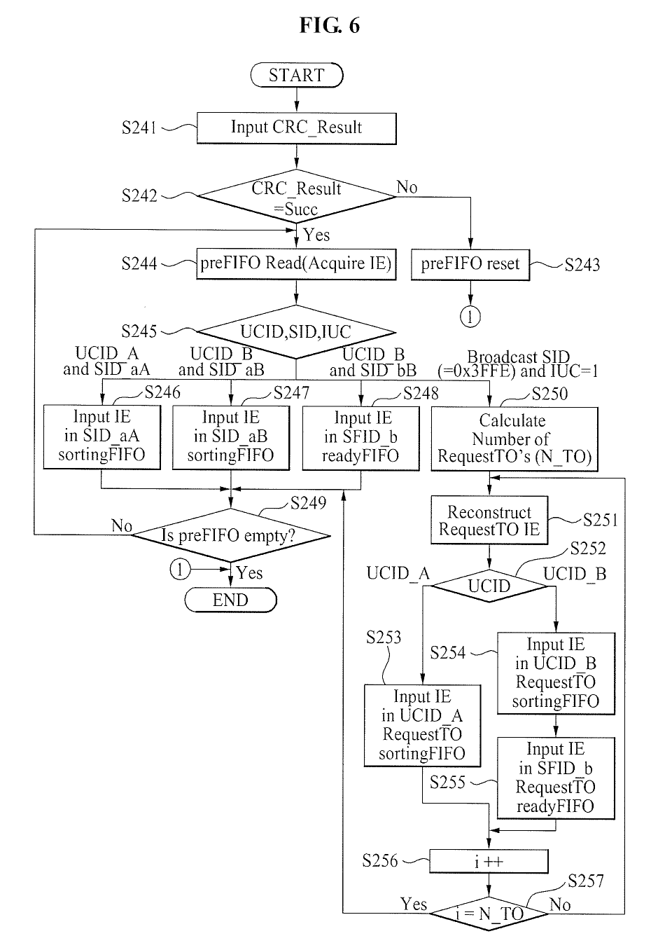

FIG. 6 is a flowchart illustrating an operation of the classifier 240 of the multi-channel MAP pre-processor according to an exemplary embodiment of the present invention.

In operation S241, the classifier 240 of the multi-channel MAP pre-processor according to an exemplary embodiment of the present invention starts an operation after receiving a CRC result from the MMM processor 145. The classifier 240 needs to be capable of determining whether the CRC result corresponds to a CRC result of a MAP for upstream channel while receiving the CRC result, however, this is not illustrated. In operation S242, success or failure is indicated based on the received CRC result. In operation S243, when the received CRC result indicates failure, all reconstructed IEs are deleted by resetting the preFIFO of the corresponding upstream channel.

In operation S244, when the received CRC result indicates success in operation S242, the classifier 240 accesses the preFIFO of the corresponding upstream channel and reads a reconstructed IE individually. In operation S245, the sortingFIFO 260 or the readyFIFO 290 to input the IE being read using a UCID value, an SID value, and an IUC value acquired by operations to operation S244 is determined. A subsequent operation of the classifier 240 is described as an example of the setting of Table 1.

In operation S246, when IE information acquired in operation S244 corresponds to UCID_A channel and SID_aA, the IE is inputted in SID_aA sortingFIFO regardless of the IUC value. In operation S247, when the IE information acquired in operation S244 corresponds to UCID_B channel and SID_aB, the IE is also inputted in SID_aB sortingFIFO regardless of the IUC value. In operation S248, since bandwidth-allocation information corresponds to the bandwidth-allocation information about a channel non-bonding service flow when the IE information acquired in operation S244 corresponds to UCID_B channel and SID_bB, the IE is immediately inputted in SFID_b readyFIFO. Operation S249 returns to operation S244 to continue performing operations S244 to S247 until the preFIFO of the predetermined upstream channel is empty.

In operation S250, when the IE information acquired in operation S244 corresponds to broadcast SID and an IUC of 1, the classifier 240 calculates a number of RequestTO's (N_TO) using Equation 3:

N_{—}TO=Duration/UnitRequestTO. [Equation 3]

In the above-described Equation 3, UnitRequestTO denotes an upstream resource size used for transmitting a resource-request message and may be calculated from upstream burst parameters included in a UCD message. UnitRequestTO calculation may be easily derived by those skilled in the art with reference to DOCSIS (CM-SP-MULPIv3.0-103-070223), however, calculation of UnitRequestTO is not illustrated.

In operation S251, the classifier 240 calculating N_TO in operation S250 generates as many RequestTO IE's as a value stored in N_TO calculated by the above-described Equation 3. A generated RequestTO IE 502 is basically the same as an IE type read in operation S244, however, a StartTime field value is set as a RequestTO StartTime value calculated as Equation 4, and a duration value is set as a UnitRequestTO value.

RequestTO StartTime=StartTime+i×UnitRequestTO, i=0,1, . . . , N_{—}TO−1 [Equation 4]

In operation S252, the classifier 240 determines a buffer to input the reconstructed RequestTO IE 502 based on the UCID value. In operation S253, when the upstream channel including the reconstructed RequestTO IE 502 corresponds to UCID_A channel, the IE is inputted in UCID_A RequestTO sortingFIFO. In operations S254 and S255, when the upstream channel including the reconstructed RequestTO IE 502 corresponds to UCID_B channel, the reconstructed RequestTO IE 502 is copied and is inputted in UCID_B RequestTO sortingFIFO and SFID_b RequestTO readyFIFO. In operation S256, a count value is incremented by one each time the reconstructed RequestTO IE 502 is inputted. In operation S257, operations S251 to S256 repeat until the count value is the same as N_TO value calculated by the above-described Equation 3.

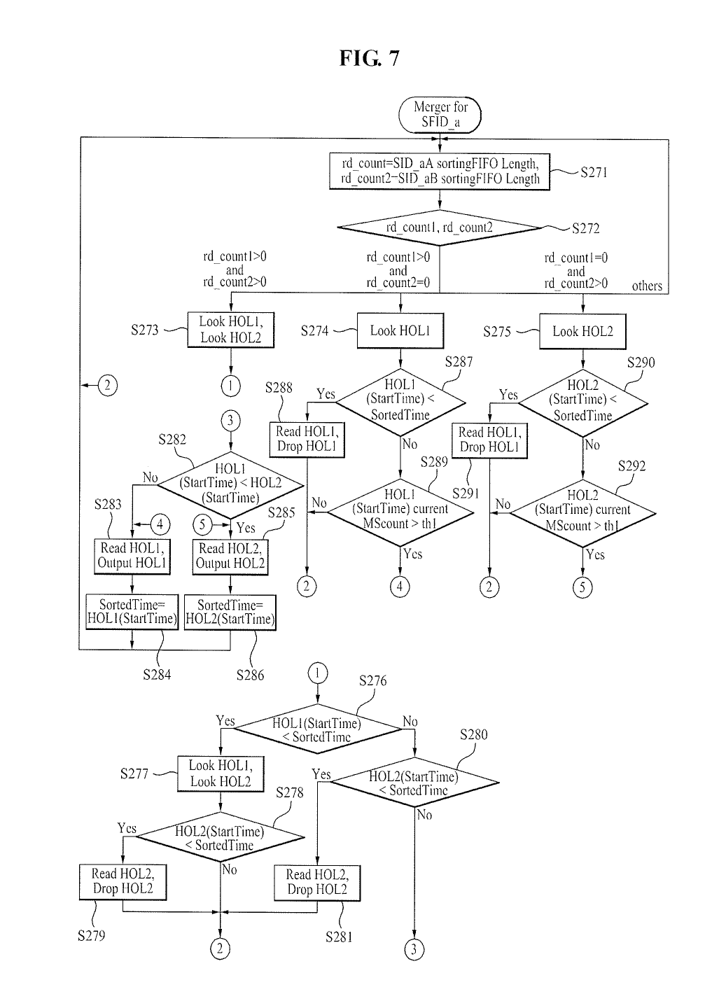

FIG. 7 is a flowchart illustrating an operation of the sorter 270 of the multi-channel MAP pre-processor according to an exemplary embodiment of the present invention.

The sorter 270 performs time sort between the IEs 501 stored in non-contention sortingFIFOs 261 and 262 classified by a channel of a service flow performing a plurality of upstream channel-bondings and time sort between the RequestTO IEs 502 stored in contention sortingFIFOs 263 and 264. In FIG. 7, time sort between SID_aA sortingFIFO 261 and SID_aB sortingFIFO 262 of SFID_a service flow is described as an exemplary embodiment of the present invention in the setting of Table 1. A process of FIG. 7 may be applied to time sort between UCID_A RequestTO sortingFIFO 263 and UCID_B RequestTO sortingFIFO 264 however, this is not illustrated.

As illustrated in FIG. 7, in operation S271, the sorter 270 verifies a length of SID_aA sortingFIFO 261 (rd_count1) and a length of SID_aB sortingFIFO 262 (rd_count2). In operation S272, the sorter 270 performs a different operation based on acquired rd_count1 and rd_count2. In operation S273, when both rd_count1 and rd_count2 are greater than 0, a first IE of SID_aA sortingFIFO 261 (hereinafter, referred to as HOL1) and a first IE of SID_aB sortingFIFO 262 (hereinafter, referred to as HOL2) are respectively pre-viewed (Look HOL1 and Look HOL2). A preview function is different from a read operation described below, and a difference between two functions denotes that the preview function does not bring the IE from the corresponding FIFO, and a read function brings the IE.

The sorter 270 performing operation S273 verifies whether a StartTime value of the previewed HOL1 and HOL2 is valid. For this, in operation S276, a StartTime field value of HOL1 (HOL1(StartTime)) is compared with a SortedTime value being a StartTime value of a most recently-sorted interval. In operation S277, when HOL1(StartTime) is less than SortedTime, HOL1 is determined as an invalid IE, and is deleted from SID_aA sortingFIFO.

In operation S278, when a StartTime field value of HOL2 (HOL2(StartTime)) is compared with a SortedTime value being a StartTime value of a most recently-sorted interval. In operation S279, when HOL2(StartTime) is less than SortedTime, HOL2 is also determined as the invalid IE, and is deleted from the SID_aB sortingFIFO. In operation S280, when HOL1 is determined to be valid in operation S276, HOL2 validity is verified similar to operation S278. In operation S281, when HOL2 is determined to be invalid in operation S280, HOL2 is deleted from the SID_aB sortingFIFO similar to operation S279. After performing operation S279 or operation S281, operations from operation S271 are performed again. In operation S282, when both HOL1 and HOL2 are determined to be valid in operations S276 and S280, a time priority is determined using StartTime field values of two IEs.

In operation S283, when an information interval of HOL1 is prior to an information interval of HOL2 based on the determining of the time priority in operation S282, HOL1 is read from SID_aA sortingFIFO and is outputted to SFID_a readyFIFO. In operation S285, when the information interval of HOL2 is prior to or the same time as the information interval of HOL1 based on the determining of the time priority in operation S282, HOL2 is read from SID_aB sortingFIFO and is outputted to SFID_a readyFIFO. In operations S284 and S286, the sorter 270 having performed operation S283 or operation S285 updates the SortedTime value to be a start value of the information interval outputting HOL1 and HOL2 to SFID_a readyFIFO.

When rd_count1 is greater than 0 and rd_count2 corresponds to 0 in operation S272, that is, when the IE is inputted in only SID_aA sortingFIFO, the sorter 270 pre-views HOL1 in operation S274, and verifies whether the StartTime field value of HOL1 is valid, by comparing pre-viewed HOL1(StartTime) and the SortedTime value in operation S287. In operation S288, when HOL1 is verified as being invalid, HOL1 is deleted from SID_aA sortingFIFO. In operation S289, when HOL1 is verified as being valid in operation S287, whether HOL1 is read and is inputted in SFID_a readyFIFO or whether a need for waiting for the time sort exists is determined. The sorter 270 uses Equation 5 for operation S289:

HOL1(StartTime)−CurrentMSCount1>threshold1. [Equation 5]

In the above-described Equation 5, currentMSCount1 corresponds to a mini-slot count value of UCID_A channel provided from the TRC block 155 of FIG. 2. Threshold1 denotes a system parameter value, and a small value if possible is preferred, however, since threshold1 corresponds to a required time value for transmitting an upstream packet from an operation after the sorter 270 to the PHY transmitter 181 of FIG. 2, threshold1 needs to be carefully set.

When the above-described Equation 5 is fulfilled in operation S289, HOL1 is read and is outputted to SFID_a readyFIFO, similar to operations S283 and S284.

When rd_count2 is greater than 0 and rd_1 corresponds to 0 in operation S272, that is, when the IE is inputted in only SID_aB sortingFIFO, the sorter 270 previews HOL2 in operation S275, and verifies whether the StartTime field value of HOL2 is valid, by comparing pre-viewed HOL2(StartTime) and the SortedTime value in operation S290. In operation S291, when HOL2 is verified as being invalid, HOL2 is deleted from SID_aB sortingFIFO. In operation S292, when HOL2 is verified as being valid in operation S290, whether HOL2 is read and is inputted in SFID_a readyFIFO or whether a need for waiting for the time sort exists is determined. The sorter 270 uses Equation 6 for operation S292:

HOL2(StartTime)−CurrentMSCount2>threshold2. [Equation 6]

In the above-described Equation 6, currentMSCount2 corresponds to a mini-slot count value of UCID_B channel provided from the TRC block 155 of FIG. 2. Threshold2 denotes a system parameter value, and a small value is preferable, however, since threshold2 corresponds to a required time value for transmitting the upstream packet from the operation after the sorter 270 to the PHY transmitter 182 of FIG. 2, threshold2 needs to be carefully set.

When the above-described Equation 6 is fulfilled in operation S292, HOL2 is read and is outputted to SFID_a readyFIFO, similar to operations S285 and S286.

In the case of two upstream channels having a mini-slot size of the same size in an exemplary embodiment of the present invention, CurrentMSCount1 and CurrentMSCount2, and threshold1 and threshold2 of the above-described Equations 5 and 6 have the same values.

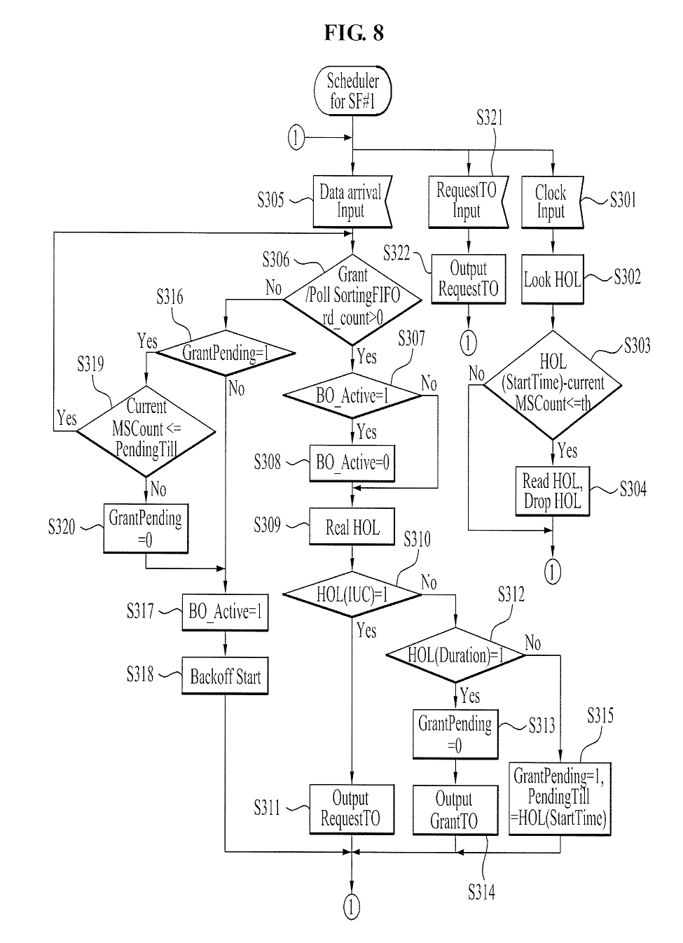

FIG. 8 is a flowchart illustrating an operation of the scheduler 300 of the multi-channel MAP processor 150 of FIG. 2.

The scheduler 300 according to an exemplary embodiment of the present invention considers operating for each service flow, and an operation of SFID_a service flow scheduler is described as an exemplary embodiment of the present invention in the setting of Table 1 with reference to FIG. 8.

The scheduler 300 accesses SFID_a readyFIFO for each operation clock in operation S301, and previews a first IE (here, this being shown as HOL) when a stored IE exists in operation S302. In operation S303, HOL(StartTime) and a current mini-slot count value are compared using Equation 7 similar to the above-described Equation 5 or the above-described Equation 6, in order to verify whether HOL is valid.

Alternatively, as illustrated in FIG. 8, requesting an input signal in operation S321 or requesting an output signal in operation S322 may be performed in parallel as required.

HOL(StartTime)−currentMSCount<=threshold3 [Equation 7]

In operation S304, when a condition of the above-described Equation 7 is fulfilled in operation S303, HOL is regarded as being invalid, is read, and is deleted.

When it is reported to the scheduler 300 that upstream data included in SFID_a service flow occurs in operation S305, the scheduler 300 accesses SFID_a readyFIFO in order to verify whether an allocation resource for transmitting occurring upstream data exists in operation S306. In operation S309, when the IE exists in SFID_a readyFIFO, the scheduler 300 reads HOL. In operation S307, the scheduler 300 determines whether a back-off for a resource-request of a contention scheme is under way. In operation S308, when the back-off is under way, the scheduler 300 commands the back-off controller 400 to stop the back-off.

In operation S310, the scheduler 300 verifies an IUC value of HOL acquired in operation S309. In operation S311, the scheduler 300 provides the upstream packet processor 160 with bandwidth information for resource-request message transmission of a non-contention scheme in the case of HOL(IUC)=1. In operation S312, when HOL(IUC) is different from 1 in operation S310, the scheduler 300 verifies a HOL(Duration) value and verifies whether the HOL(Duration) value corresponds to Grant for data transmission or GrantPending. When HOL(Duration) is greater than 0 in operation S312, this denotes Grant information being bandwidth allocation for data transmission, and when a previous state corresponds to GrantPending, the scheduler 300 resets a GrantPending value as 0 in order to remove GrantPending in operation S313, and provides the upstream packet processor 160 with bandwidth-allocation information in operation S314.

In operation S315, since a CMTS prohibits a CM from performing the resource-request of the contention scheme for a predetermined time when HOL(Duration) corresponds to 0, the scheduler 300 sets GrantPending as 1, and sets a resource-request prohibition termination time value (PendingTill) as a HOL(StartTime) value.

When a resource allocated at a time when the resource request for an upstream packet occurs does not exist in operation S306, the scheduler 300 requests a resource-request opportunity of the contention scheme for the back-off controller 400. For this, in operation S316, the scheduler 300 verifies whether a current state corresponds to a GrantPending state. In operation S317, when the current state is different from the GrantPending state, the scheduler 300 reports the resource-request opportunity of the contention scheme for the back-off controller 400.

In operation S318, when the current state corresponds to the GrantPending state (GrantPending=1) in operation S316, the scheduler 300 compares a current mini-slot count value and the resource-request prohibition termination time value (a PendingTill value) being set in operation S315. When resource-request prohibition is terminated, that is, when the current mini-slot count value is greater than the PendingTill value, the scheduler 300 removes the GrantPending state by resetting the GrantPending value in operation S319, and requests the resource-request opportunity of the contention scheme for the back-off controller 400 similar to operation S317.

The scheduler 300 requesting the resource-request opportunity of the contention scheme similar to operation S317 waits for a response from the back-off controller 400. When the response is inputted in operation S320, the scheduler 300 provides the upstream packet processor 160 with inputted resource-request opportunity information of the contention scheme.

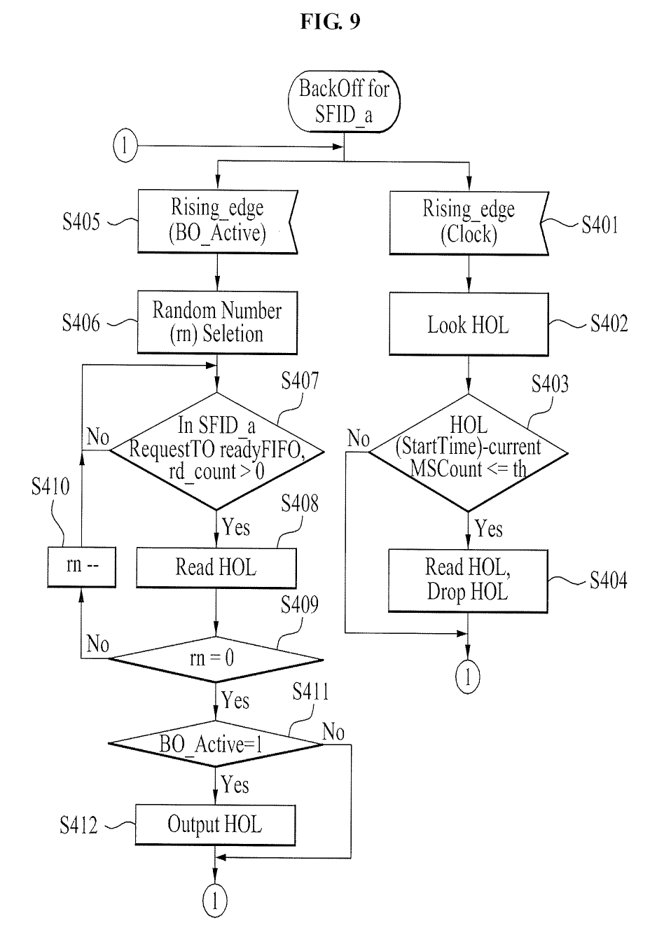

FIG. 9 is a flowchart illustrating an operation of the back-off controller 400 of the multi-channel MAP processor 150 of FIG. 2.

The back-off controller 400 considers operating for each service flow, and an operation of SFID_a service flow back-off controller is described as an exemplary embodiment of the present invention in the setting of Table 1 with reference to FIG. 9.

The back-off controller 400 accesses SFID_a readyFIFO for each operation clock in operation S401, and previews a first IE (here, this being shown as HOL) when a stored IE exists in operation S402. In operation S403, HOL(StartTime) and a current mini-slot count value are compared using the above-described Equation 7 in order to verify whether HOL is valid. In operation S404, when a condition of the above-described Equation 7 is fulfilled in operation S403, HOL is regarded as being invalid, is read, and is deleted.

When the back-off controller 400 receives a resource-request opportunity selection request from the scheduler 300 in operation S405, the back-off controller 400 first selects a random integer ‘rn’ in operation S406. The selecting of the random integer in operation S406 uses a well-known binary exponential back-off scheme. DOCSIS may be referred to for content details.

In operation S407, the back-off controller 400 accesses SFID_a RequestTO readyFIFO in which the resource-request opportunity information of the contention scheme is sorted by a time ascending series after selecting the random integer. In operation S408, when a length of SFID_a RequestTO readyFIFO (rd_count) is greater than 0, that is, when a RequestTO IE is inputted, the back-off controller 400 reads HOL. In operation S409, when comparison result values are different from each other in operation S409, the back-off controller 400 verifies whether ‘rn’ selected in operation S406 corresponds to 0 in order to verify whether HOL is valid. When the comparison result values are different from each other in operation S409, the back-off controller 400 determines read HOL to be invalid, deletes HOL, and simultaneously reduces ‘rn’ by one in operation S410, and subsequently performs operation S407 again. The reducing ‘rn’ by one similar to operation S410 is for waiting for as many RequestTO's as ‘rn’ selected in operation S406.

In operation S411, when a process from operations S407 to S410 is repeatedly performed and ‘rn’ is set as 0, the back-off controller 400 verifies whether the scheduler 300 is still requesting the resource-request opportunity selection of the contention scheme. This denotes that the scheduler 300 verifies whether a BO_Active signal value provided for the back-off controller 400 is maintained as 1, and performing operation S411 is caused by a fact that the BO_Active signal value is changed to 0 when the scheduler 300 acquires an allocated resource during back-off. In operation S412, when the BO_Active signal value is verified as being maintained as 1 in operation S411, the back-off controller 400 transmits HOL to the scheduler 300.

The method of processing the bandwidth-allocation information in the CM with the multiple transmitting and receiving channels according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, it is possible to sort bandwidth-allocation information for a plurality of upstream channels according to a time priority between channels and to classify the bandwidth-allocation information by a service flow in a CM system for increasing an upstream transmission speed using a channel-bonding scheme, thereby easily processing the bandwidth-allocation information.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of processing bandwidth-allocation information in a cable modem (CM) with multiple transmitting and receiving channels, the method comprising:
receiving, by a Mini-slot Allocation Packet (MAP) pre-processor, MAP data from a Media Access Control (MAC) Management Message (MMM) processor, reconstructing the MAP data into an Information Element (IE), and sorting bandwidth-allocation IEs between channels according to a time sequence;
reporting, to an upstream scheduler, whether upstream data is generated, and returning, by the upstream scheduler, the bandwidth-allocation information for upstream data transmission of the IE sorted by the MAP pre-processor; and
performing, by a back-off controller, a back-off function and returning contention-based resource-request opportunity information when the back-off controller receives a back-off driving signal from the upstream scheduler.

2. The method of claim 1, wherein the receiving, reconstructing, and sorting comprises:
performing filtering, and reconstructing a MAP IE;
filtering the IE and storing a bandwidth-allocation IE of each channel reconstructed by a reconstruction unit;
receiving Cyclic Redundancy Check (CRC) result information from the MMM processor, processing the CRC result information, and classifying the bandwidth-allocation IEs by at least one of an Upstream Channel Identifier (UCID) value, a Service Identifier (SID) value, and an Interval Use Code (IUC) value, the bandwidth-allocation IEs being read from a first buffer;
storing non-contention bandwidth-allocation information and contention bandwidth-allocation information based on the classifying;
performing time sort of two IE lists between the channels, the two IE lists being sorted according to the time sequence; and
storing the IEs being time-sorted between the channels.

3. The method of claim 2, wherein the performing of the filtering and reconstructing of the MAP IE comprises:
receiving the MAP data from the MMM processor;
verifying the UCID value being a first byte of a received MAP message payload;
receiving mandatory fields of the subsequently-received MAP message payload when the UCID value is known;
determining validity of a bandwidth allocation time value from among the received mandatory fields;
calculating a number of IEs to recognize an end of the MAP message payload when the bandwidth allocation time value is determined to be valid;
receiving a single complete IE and performing a comparison to verify whether the SID value of the single complete IE is related to the CM; and
reconstructing the corresponding IE when the SID value is verified as being related to the CM.

4. The method of claim 3, wherein the determining sets a value being greater than or equal to another value being a sum of a previous allocation start time, a previous MAP length, and ‘1’ as a current allocation start time using MAP information including the same UCID value, and calculates a valid bandwidth allocation time.

5. The method of claim 3, wherein the reconstructing of the corresponding IE comprises:
enabling the SID value and the IUC of the received IE to correspond to an SID value and an IUC of a second buffer;
enabling a start time of the second buffer to correspond to a value of summing a start time of the IE and an offset value of the IE received at a bandwidth allocation time;
enabling an interval value of the second buffer to correspond to a value of subtracting a current input IE value from a next IE offset value; and
storing the reconstructed IE in a first buffer for each upstream channel after reconstruction of the IE is completed.

6. The method of claim 3, further comprising:
deleting the MAP data, received up until a current time, and the subsequently-received MAP data when the bandwidth allocation time value is determined to be invalid.

7. The method of claim 2, wherein the receiving and processing of the CRC result information and classifying of the bandwidth-allocation IEs comprises:
receiving a CRC result from the MMM processor;
determining whether the received CRC result indicates success;
acquiring an IE value reconstructed in a first buffer of a corresponding upstream channel when the CRC result is determined to indicate success;
determining a second buffer and a third buffer to store the read IE value using the UCID value, the SID value, and the IUC value of the acquired IE; and
allocating the reconstructed IE value to the determined buffers based on the UCID value.

8. The method of claim 2, wherein the performing of the time sort comprises:
inspecting a length of a plurality of second buffers;
previewing a first IE value of each buffer when all data is inspected to be stored in each second buffer;
verifying validity of a start time value of a first IE of each previewed buffer; and
determining a time priority using start time field values of the two IEs when all start time values of the IE of each buffer are verified as being valid.

9. The method of claim 8,
when the IE is stored in any single buffer,
further comprising:
previewing the start time value of the buffer storing the IE;
comparing the previewed start time value and a storage time and verifying whether the value stored in the buffer is a valid value; and
determining whether the value stored in the buffer is immediately stored in a third buffer or whether a need for waiting for the time sort exists when the stored value is determined to be valid.

10. The method of claim 1, wherein the reporting and returning comprises:
reporting, to the upstream scheduler by an upstream packet processor, whether the upstream data is generated;
verifying whether the bandwidth-allocation information to be transmitted without contention based on the reporting exists;
requesting a contention-based resource-request opportunity for the back-off controller when the bandwidth-allocation information to be transmitted without contention is verified as not existing; and
returning the bandwidth-allocation information for corresponding data transmission based on the requested opportunity.

11. The method of claim 1, wherein the performing of the back-off function and returning of the contention-based resource-request opportunity information comprises:
previewing a first IE when the IE stored in a third buffer exists for each operation clock;
determining whether the preview value is valid;
selecting a random integer when a resource-request opportunity selection request of a contention scheme is received from the upstream scheduler;
accessing the third buffer in which the resource-request opportunity information of the contention scheme is sorted by a time ascending series after selecting the random integer;
reading a value of the IE and determining whether the value is valid when the IE is received in the third buffer; and
verifying whether the upstream scheduler is still requesting the resource-request opportunity selection of the contention scheme.

12. A multi-channel MAP processor comprising:
a MAP pre-processor to receive MAP data from an MMM processor, to reconstruct the MAP data into an IE, to classify bandwidth-allocation IEs by each value, and to sort the bandwidth-allocation IEs between channels according to a time sequence;
an upstream scheduler to which an upstream packet processor reports whether upstream data is generated, and to return the bandwidth-allocation information for upstream data transmission of the IE sorted by the MAP pre-processor; and
a back-off controller to perform a back-off function and to return contention-based resource-request opportunity information when the back-off controller receives, from the upstream scheduler, a back-off driving signal based on a resource-request opportunity selection request of a contention scheme.

13. The multi-channel MAP processor of claim 12, wherein the MAP pre-processor comprises:
an IE filtering and reconstruction unit to perform filtering and to reconstruct a MAP IE;
a first buffer to filter the IE and to store a bandwidth-allocation IE of each channel reconstructed by a reconstruction unit;
a classifier to receive CRC result information from the MMM processor, to process the CRC result information, and to classify the bandwidth-allocation IEs by a UCID value, an SID value, and an IUC value, the bandwidth-allocation IEs being read from the first buffer;
a second buffer to store non-contention bandwidth-allocation information and contention bandwidth-allocation information based on the classifying of the classifier;
a sorter to sort two time-sorted IE lists with each other and to perform time sort of the two IE lists; and
a third buffer to store the IEs being time-sorted between the channels according to the sorter.
